(19) United States
(12) Patent Application Publication
(10) Pub. No.: US 2010/0081972 A1
(43) Pub. Date: Apr. 1, 2010

(54) MASSAGE UNIT AND CHAIR-TYPE MASSAGE MACHINE HAVING THE UNIT

(75) Inventors: Yuji Kan, Kasai-shi (JP); Hidefumi Nomura, Himeji-shi (JP); Shinichi Hagino, Himeji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Osaka (JP); SANYO CONSUMER ELECTRONICS CO., LTD., Tottori-shi (JP)

(21) Appl. No.: 12/570,855

(22) Filed: Sep. 30, 2009

(30) Foreign Application Priority Data
Sep. 30, 2008 (JP) 2008-252721

(51) Int. Cl. A61H 7/00

(52) U.S. Cl. 601/99

(57) ABSTRACT

The invention provides a massage unit of reduced weight and low cost which is adapted to grip and knead the affected part of the user with upper and lower therapeutic members. The massage unit comprises: a kneading shaft (30) rotatably supported on a chassis (21), two output shaft portions (32) provided on the kneading shaft and inclined in directions opposite to each other with respect to an axis of the kneading shaft, a pair of left and right pivotal levers (60) each rotatably fitted at a base end thereof around the output shaft portion and having a free end portion projecting toward the person to be treated, the pivotal levers being movable by the rotation of the kneading shaft axially of the shaft, a first therapeutic member (40) provided on a forward end of each of the pivotal levers, an auxiliary lever (70) pivoted to an inside portion of the pivotal lever, an angle limiting member (90) having one end connected to a base end portion of the auxiliary lever and the other end connected to the chassis for limiting the angle of pivotal movement of the auxiliary lever, a pivotal arm (80) pivoted to the pivotal lever and so supported as to be slidable relative to the auxiliary lever, and a second therapeutic member (50) provided on an end of the pivotal arm, the first therapeutic member and the second therapeutic member being movable toward and away from each other by rotating the kneading shaft.

### TECHNICAL FIELD

The present invention relates to massage units comprising a first therapeutic member and a second therapeutic member which are movable toward and away from each other for gripping and kneading the shoulder of the person to be treated, and to chair-type massage machines including the unit.

### BACKGROUND OF THE INVENTION

Massage machines of the chair type are known which comprise a massage unit for giving a massage to the shoulder, back and waist of the person to be treated.

Such chair-type massage machines include those having a massage unit which comprise a first therapeutic member and a second therapeutic member arranged one above the other and movable toward and away from each other for kneading the shoulder of the person to be treated (see, for example, Patent Literature 1: Patent No. 4046702).

With the massage unit of Patent Literature 1, the first therapeutic member is attached by a pivotal arm to a pivotal lever movable upward, downward, leftward and rightward, and the second therapeutic member is supported by the pivotal lever and slidable relative to the pivotal arm.

The pivotal arm is connected to a chassis by a ball link so as to be limited in the angle of pivotal movement. The first and second therapeutic members are movable toward and away from each other by moving the pivotal lever upward, downward, leftward and rightward.

The pivotal arm carrying the first therapeutic member thereon is restrained by the ball link with respect to the angle of its pivotal movement, so that the force to be delivered to the first member through the pivotal arm by the pivotal movement of the lever is reduced as a loss before it is delivered to the first member.

Since the first therapeutic member massages the shoulder of the user from above (see, for example, FIG. 3), the member needs to exert a great force on the affected part of the person. If the great force is cause to act on the affected part (e.g., on the shoulder), the pivotal lever warps, entailing a greater loss. To give a kneading feel with a diminished loss, there arises a need to give a stout structure to the pivotal lever and arm for delivering the force to the first member therethrough, whereas the two members of stout structure render the massage unit greater in size, weight and cost.

Further because the power is delivered to the second therapeutic member through the same pivotal arm as the first member, a sufficient force will not be transmitted to the second member, while the pivotal arm is subjected to a great force, with the result that the massage unit becomes similarly greater in size and weight and more costly.

An object of the present invention is to provide a massage unit of reduced weight and low cost which is adapted to grip and knead the affected part of the user with upper and lower therapeutic members.

### SUMMARY OF THE INVENTION

To fulfill the above object, the present invention provides a massage unit comprising:
a kneading shaft rotatably supported on a chassis,
two output shaft portions provided on the kneading shaft and inclined in directions opposite to each other with respect to an axis of the kneading shaft,
a pair of left and right pivotal levers each rotatably fitted at a base end thereof around the output shaft portion and having a free end portion projecting toward the person to be treated, the pivotal levers being movable by the rotation of the kneading shaft axially of the shaft,
a first therapeutic member provided on a forward end of each of the pivotal levers,
an auxiliary lever pivoted to an inside portion of the pivotal lever,
an angle limiting member having one end connected to a base end portion of the auxiliary lever and the other end connected to the chassis for limiting the angle of pivotal movement of the auxiliary lever,
a pivotal arm pivoted to the pivotal lever and so supported as to be slidable relative to the auxiliary lever, and
a second therapeutic member provided on an end of the pivotal arm,
the first therapeutic member and the second therapeutic member being movable toward and away from each other by rotating the kneading shaft.

With the massage unit of the present invention, the first therapeutic member is supported directly by the pivotal lever, and the pivotal arm having the second therapeutic member thereon is pivoted to the pivotal lever and receives a force through the auxiliary lever when the second member is moved toward and away from the first therapeutic member.

Since the first therapeutic member is supported directly by the pivotal lever, the force delivered from the pivotal lever can be caused to act on the affected part almost without any loss to produce an enhanced massage effect.

The force acting on the pivotal lever, auxiliary lever and pivotal arm can be smaller than in the conventional massage unit by a great amount corresponding to the reduction of loss. For this reason, the pivotal lever, auxiliary lever and pivotal arm need not be given a stout structure unlike those of the conventional unit. These components can be made, for example, from a resin.

Accordingly the massage unit can be reduced in weight, size and cost.

### BRIEF DESCRIPTION OF THE DRAWINGS

FIG. 1 is a perspective view of a chair-type massage machine having installed therein a massage unit of the invention;

FIG. 2 is a perspective view of the massage unit;

FIG. 3 is an illustration showing first therapeutic members as positioned in bearing contact with the respective shoulders of the person to be treated;

FIG. 4 is a perspective view of a massage unit wherein two kneading balls serve as a first therapeutic member;

FIG. 5 is an illustration showing the two kneading balls as positioned in bearing contact with each shoulder of the person;

FIG. 6 is a perspective view of a massage unit wherein two kneading balls which are different in outside diameter serve as a first therapeutic member; and

FIG. 7 is an illustration showing the two kneading balls of different outside diameters as positioned in bearing contact with each shoulder of the person.

### DESCRIPTION OF THE PREFERRED EMBODIMENTS

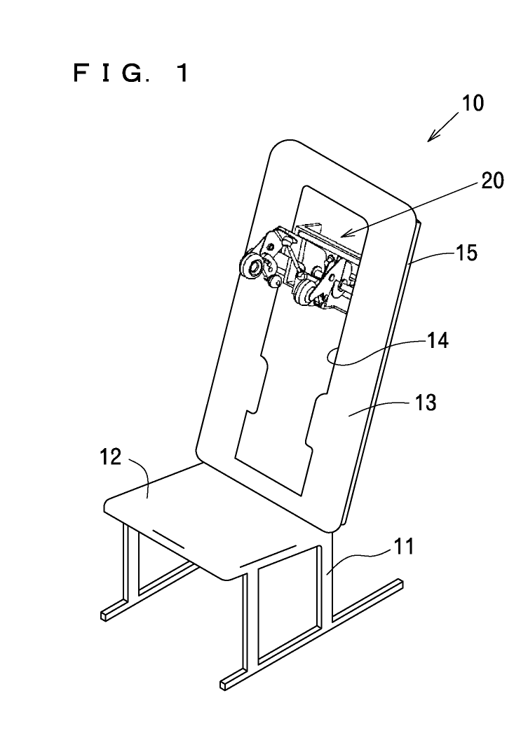

FIG. 1 is a perspective view of a chair-type massage machine 10 having installed therein a massage unit 20 of the present invention. For a better understanding, FIG. 1 shows a base frame 11, seat chassis 12, backrest chassis 13 and the massage unit 20 only of the massage machine 10.

The backrest chassis 13 has a vertically elongated opening 14 in its center. The massage unit 20 is positioned as projected from the opening 14.

The backrest chassis 13 is provided on its rear side with a pair of opposed guide rails 15 extending upward or downward. The guide rails 15 have respective channel-shaped grooves opposed to each other for rollably fitting therein rollers 22, 24 of the massage unit 20 to be described later. A rack is formed in a rail edge defining the opening of the groove for meshing engagement with a gear 22a of the massage unit 20.

The massage unit 20 has a pair of upper and lower members, i.e., first therapeutic member 40 and second therapeutic member 50 which are movable toward and away from each other, such that the two members 40, 50 give a massage to the shoulder or like affected part of the person to be treated as by gripping and kneading with the thumb and four members of a person.

The massage unit 20 consists basically of a chassis 21 which is provided with the rollers 22, 24 arranged one above the other and rollably fitting in the guide rails 15 on the backrest chassis 13. The rollers 22, 24 are attached to the chassis 21 by respective shafts 23, 25. The gear 22a meshing with the rack of the guide rail 15 is formed on the inner side of the upper roller 22. The shaft 23 supporting the upper roller 22 and the gear 22a extends through the chassis 21 transversely thereof, is connected to an unillustrated lift motor and is rotatable by being driven by the lift motor for moving the massage unit 20 upward and downward relative to the backrest chassis 13.

Provided approximately in the center of the chassis 21 transversely thereof are a kneading shaft 30 and a tapping shaft 35 below the shaft 30. The kneading shaft 30 and the tapping shaft 35 are connected to a kneading motor and a tapping motor (neither shown), respectively, each by way of a reduction mechanism and are rotatable by being driven by the respective motors.

Provided on the kneading shaft 30 are two output shaft portions 32, 32 which are eccentric and inclined in directions opposite to each other with respect to the shaft axis.

Supported on the tapping shaft 35 are two eccentric cams (not shown) which are out of phase with each other by 180 deg. A pivotal lever 60 to be described below is connected at a portion thereof rearward from the kneading shaft 30 to the eccentric cam by a universal joint and a rod.

Incidentally, the kneading shaft 30 and the tapping shaft 35 have the same construction as in the foregoing Patent Literature 1.

A pair of opposite pivotal levers 60, 60 are rotatably fitted around the respective output shaft portions 32, 32 of the kneading shaft 30. Each of the pivotal levers 60, 60 is coupled at the rear end thereof to the eccentric cam on the tapping shaft 35 by the universal joint and rod.

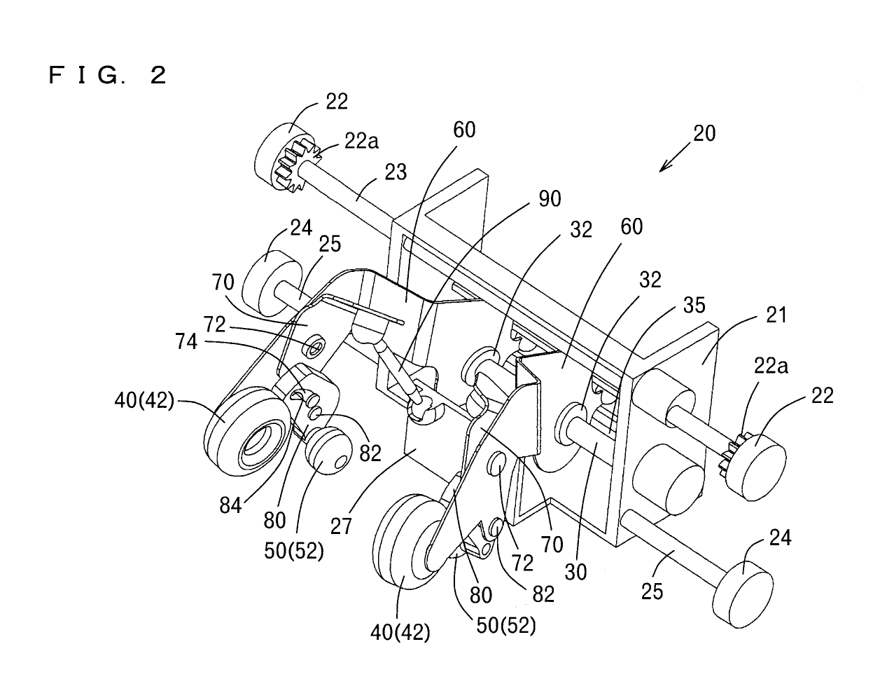

With reference to FIG. 2, the pivotal lever 60 has a free end portion which is bent outward and further bent so as to extend forward. The first therapeutic member 40 for massaging the affected part of the person to be treated is mounted on the forward end of the pivotal lever 60. The member 40 can be rotatably supported by a shaft on the inner side of the pivotal lever 60. As shown in FIG. 2, the member 40 can be a kneading ball 42 having a circular outer periphery.

An auxiliary lever 70 is movably supported by a pivot 72 on each pivotal lever 60 at a position rearwardly of the lever portion supporting the first therapeutic member 40. Projecting inward from the auxiliary lever 70 at a portion thereof forward from the pivot 72 is a pin 74 for allowing the pivotal movement of the pivotal arm 80 supporting the second therapeutic member 50 thereon. The portion of the auxiliary lever 70 rearward from the pivot 72 is bent inward and connected by an angle limiting member 90 to the chassis 21.

As shown in FIG. 2, the angle limiting member 90 can be a ball link of universal joint structure having one end connected to the auxiliary lever 70 by a universal joint and the other end joined by a universal joint to a bracket 27 provided at the front end of the chassis 21.

The pivotal arm 80 is pivoted as at 82 to the pivotal lever 60 at a position below the pivot 72 for the auxiliary lever 70. The second therapeutic member 50 is rotatably supported by the pivotal arm 80 at its lower end. The second member 50 can be, for example, a generally spherical kneading ball 52 as seen in FIG. 2.

A slit 84 in the form of a circular-arc protruding rearward is formed in the pivotal arm 80 at a portion thereof above the pivot 82. The slit 84 has fitted therein the pin 74 provided on the auxiliary lever 70.

With the massage unit 20 of the foregoing structure, the pivotal lever 60 is supported by the output shaft portion 32 eccentrically as inclined, while the rear end portion of the lever 60 is connected to the tapping shaft 35 by the rod and another member. Accordingly, the rotation of the kneading shaft 30 moves the opposite pivotal levers 60, 60 upward, downward, leftward and rightward. This also moves the first therapeutic members 40, 40 on the forward ends of the pivotal levers 60, 60 upward, downward, leftward and rightward, giving a kneading massage to the affected part of the person to be treated.

Since the auxiliary lever 70 is pivoted to the pivotal lever 60 thus moved, the auxiliary lever 70 acts to move following the movement of the pivotal lever 60, whereas the auxiliary lever is coupled by the angle limiting member 90 to the chassis 21 and therefore moves in the following mode.

FIG. 2 shows the pivotal levers 60, 60 as they are so moved as to bring the opposite first therapeutic members 40, 40 closest to each other in a lower position.

When the kneading shaft 30 is rotated in this state, the output shaft portions 32, 32 pivotally move the pivotal levers 60, 60 upward and/or away from each other. Although each auxiliary lever 70 has its pivot 72 pulled upward and/or outward, the lever rear end portion, which is connected to the angle limiting member 90, is pulled so that the lever 70 is so moved as to bring its forward end upward relative to the pivotal lever 60.

The pin 74 on the auxiliary lever 70 moves along a circular-arc path centered about the pivot 72, while the slit 84 of the pivotal arm 80 is in a circular-arc shape facing toward an opposite direction to the path. Further the pivotal arm 80 is pivoted as at 82 to the pivotal lever 60. Accordingly, when the pin 74 on the auxiliary lever 70 moves upward, the pin 74 slidingly moves upward through the slit 84.

Consequently, the pivotal arm 80 moves in such a direction that the second therapeutic member 50 moves away from the first therapeutic member 40.

In this way, the first and second members 40, 50 move away from each other while moving upward.

When the kneading shaft 30 further rotates, the output shaft portions 32, 32 cause the pivotal levers 60 to move downward and/or toward each other. Although each auxiliary lever 70 has its pivot 72 pulled downward and/or inward, the rear end portion of the lever 70 is connected to the angle limiting member 90 and is therefore pushed up, with the result that the lever 70 is moved so that the forward end thereof (the portion of pin 74) moves down relative to the pivotal lever 60.

The pivotal arm 80 is pivoted as at 82 to the pivotal lever 60, so that when the pin 74 on the auxiliary lever 70 moves downward along a circular-arc path centered about the pivot 72, the pin 74 slidingly moves down through the slit 84 in the pivotal arm 80 as shown in FIG. 2.

As a result, the pivotal arm 80 moves in such a direction that the second therapeutic member 50 is brought toward the first therapeutic member 40.

In this way, the first and second therapeutic members 40, 50 move toward each other while moving downward.

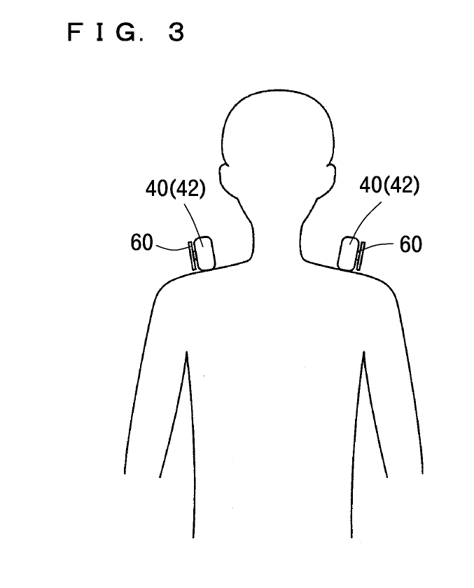

Continued rotation of the kneading shaft 30 causes the first and second therapeutic members 40, 50 to move toward each other while moving the members downward for the members to grip the affected part of the person to treated, further causing the members to move away from each other to release the affected part while moving the members upward. By repeating these movements, the massage unit grips and kneads the affected part for a massage. For example when the shoulders of the person to be treated are positioned in contact with the first therapeutic members 40 as seen in FIG. 3, the shoulders are massaged by gripping and kneading.

With the massage unit 20 of the present invention, the first therapeutic member 40 is supported directly by the pivotal lever 60, and the pivotal arm 80 having the second therapeutic member 50 thereon is pivoted to the pivotal lever 60 and receives a force through the auxiliary lever 70 when the second member 50 is moved toward and away from the first therapeutic member 40.

Since the first therapeutic member 40 is supported directly by the pivotal lever 60, the force delivered from the pivotal lever 60 can be caused to act on the affected part almost without any loss to produce an enhanced massage effect.

The force acting on the pivotal lever 60, auxiliary lever 70 and pivotal arm 80 can be smaller than in the conventional massage unit by a great amount corresponding to the reduction of loss. For this reason, the pivotal lever 60, auxiliary lever 70 and pivotal arm 80 need not be given a stout structure unlike those of the conventional unit. These components can be made, for example, from a resin.

Accordingly the massage unit 20 can be reduced in weight, size and cost.

With the foregoing embodiment, the output shaft portions 32, 32 are inclined in directions opposite to each other and eccentric with respect to the axis of the kneading shaft 30, such that the rotation of the kneading shaft 30 moves the pivotal lever 60 leftward, rightward, upward and downward, whereas the output shaft portions 32, 32 need not always be made eccentric with respect to the axis of the kneading shaft 30 but can be merely inclined.

In this case, the pivotal lever 60 is oscillated to the left and right by the rotation of the kneading shaft 30. This leftward and rightward movement of the pivotal lever 60 enables the first and second therapeutic members 40, 50 to move toward and away from each other repeatedly.

Further according to the above embodiment, the pivotal arm 80 pivoted as at 82 to the pivotal lever 60 is provided with the slit 84, in which pin 74 on the auxiliary lever 70 is fitted, whereas the pivotal arm 80 may be supported by a pivot 82 on the auxiliary lever 70 for a pin 74 provided on the pivotal lever 60 to fit in the slit 84 formed in the pivotal arm 80.

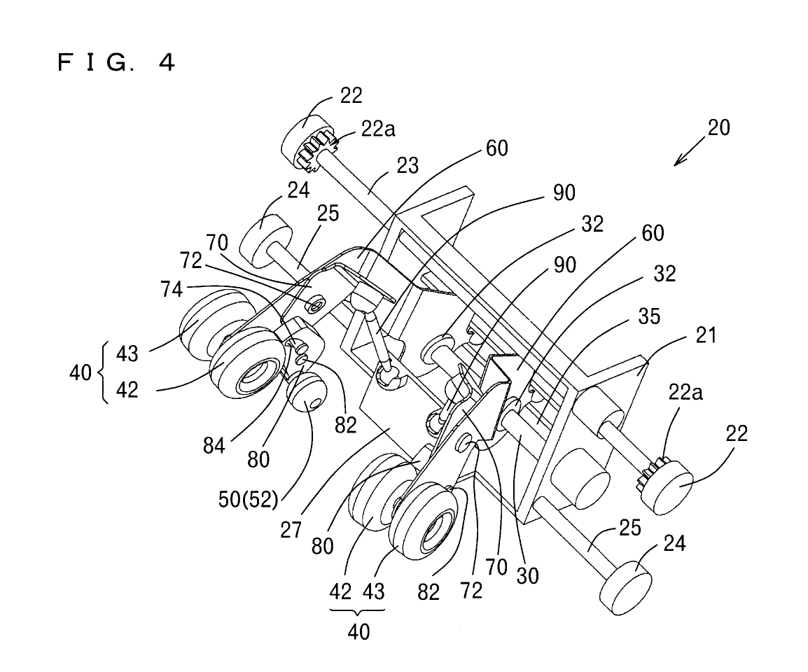

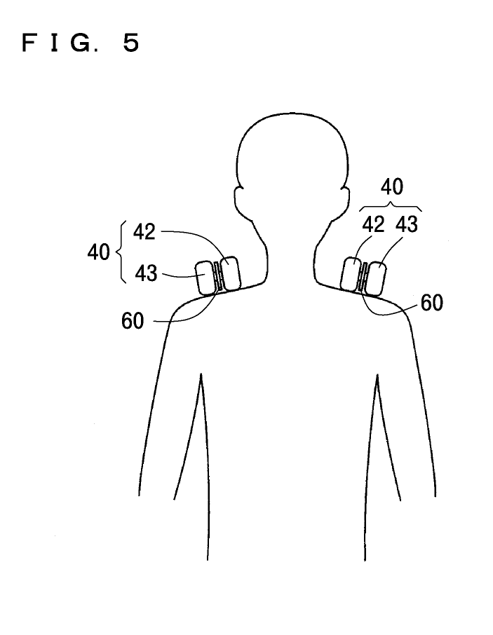

With respect to the first therapeutic member 40, kneading balls 42, 43 can be arranged respectively on opposite sides of the pivotal lever 60 as seen in FIGS. 4 and 5. If the first therapeutic member 40 is provided on only one side (inner side) of the pivotal lever 60 as shown in FIGS. 2 and 3, the force exerted by the affected part on the first member 40 produces a torsional moment on the pivotal lever 60 during massage (especially during a kneading massage). To avoid this influence, there arises a need to give an increased thickness to the pivotal lever 60 to ensure strength. This leads to an increase in weight and cost. The pivotal lever 60 can be made almost free from torsional moment by providing the kneading balls 42, 43 on opposite sides of the lever 60 as shown in FIGS. 4 and 5, and can therefore be reduced in weight and cost. Furthermore, the width of the first member 40 can be doubled for a wider therapeutic application to ensure a useful massage.

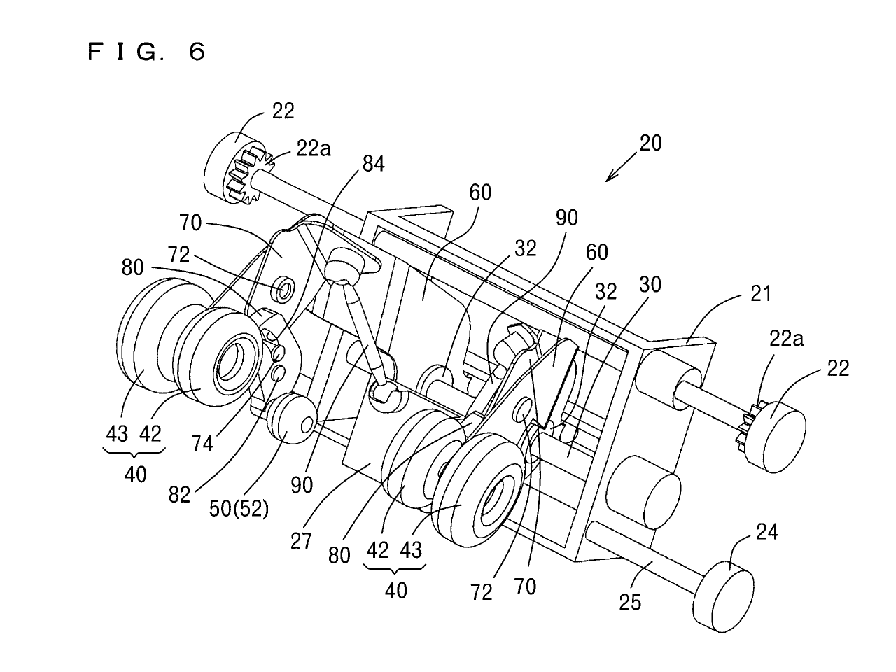

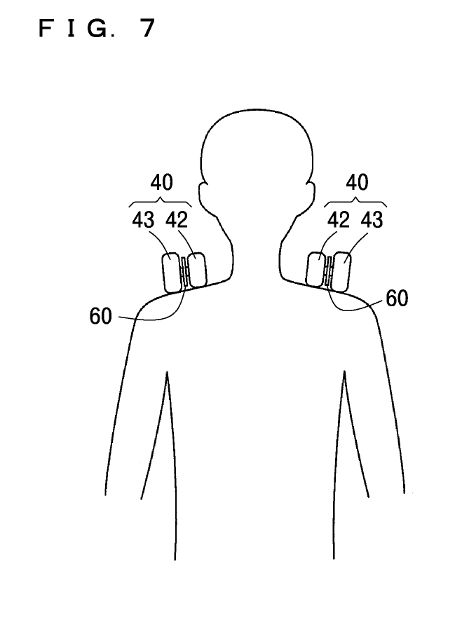

In this case, it is further desirable to make the outer kneading ball 43 greater than the inner kneading ball 42 in outside diameter as shown in FIGS. 6 and 7. With reference to FIG. 7, the shoulders and the back of the person to be treated have a greater height in the center of the body and become lower toward the outer sides of the body, so that the kneading ball 42, 43 can be made smaller toward the inner side and greater on the outer sides in outside diameter. This enables the kneading balls 42, 43 to give uniform pressure on the affected part, hence the advantage of an enhanced massage effect.

The present invention provides a massage unit having therapeutic members adapted to grip and knead the affected part of the person to be treated, and useful chair-type massage machines comprising the unit.

What is claimed is:

1. A massage unit characterized in that the unit comprises:
a kneading shaft rotatably supported on a chassis,
two output shaft portions provided on the kneading shaft and inclined in directions opposite to each other with respect to an axis of the kneading shaft,
a pair of left and right pivotal levers each rotatably fitted at a base end thereof around the output shaft portion and having a free end portion projecting toward the person to be treated, the pivotal levers being movable by the rotation of the kneading shaft axially of the shaft,
a first therapeutic member provided on a forward end of each of the pivotal levers,
an auxiliary lever pivoted to an inside portion of the pivotal lever,
an angle limiting member having one end connected to a base end portion of the auxiliary lever and the other end connected to the chassis for limiting the angle of pivotal movement of the auxiliary lever,
a pivotal arm pivoted to the pivotal lever and so supported as to be slidable relative to the auxiliary lever, and
a second therapeutic member provided on an end of the pivotal arm,
the first therapeutic member and the second therapeutic member being movable toward and away from each other by rotating the kneading shaft.

2. The massage unit according to claim 1 wherein the first therapeutic member comprises a pair of kneading balls arranged on opposite sides of the pivotal lever.

3. The massage unit according to claim 2 wherein the outer kneading ball is greater than the inner kneading ball in outside diameter.

4. The chair-type massage machine characterized in that a massage unit according to claim 1 is provided upwardly and downwardly movably on a backrest for the back of the person to be treated to come into contact therewith.
